(19) United States
(12) Patent Application Publication
(10) Pub. No.: US 2025/0109954 A1
(43) Pub. Date: Apr. 3, 2025

(54) VEHICLE ROUTING SERVICE FOR AUTONOMOUS VEHICLE RIDE SERVICE

(71) Applicant: Micron Technology, Inc., Boise, ID (US)

(72) Inventors: Mohad Baboli, Boise, ID (US); John Hopkins, Meridian, ID (US)

(21) Appl. No.: 18/775,052

(22) Filed: Jul. 17, 2024

Related U.S. Application Data
(60) Provisional application No. 63/541,584, filed on Sep. 29, 2023.

(51) Int. Cl. G01C 21/34; B60W 60/00; G06Q 30/0251; G06Q 30/0273; G06Q 50/47

(52) U.S. Cl. CPC G01C 21/3484; G06Q 30/0266; G06Q 30/0275; G06Q 50/47; B60W 60/00253

(57) ABSTRACT

A system and method for optimizing routes for an autonomous vehicle ride service based on business promotions and incentives. A vehicle routing service identifies multiple possible routes between a rider's pick-up and drop-off locations that meet time and distance requirements. For each route, an expected monetary value is calculated based on promotions from businesses located near the route. Businesses provide promotions with bid values via an integrated promotion management platform. The route with the highest expected value based on associated promotion bid values is selected and provided to the autonomous vehicle. Promotion content is transmitted to vehicle displays or the rider's mobile device. The rider can accept offers to re-route to a business. The system continually evaluates new promotions for additional revenue opportunities. By optimizing routes based on promotions and incentives, the system maximizes value for riders, businesses, and the ride service.

### PRIORITY APPLICATION

This application claims the benefit of priority to U.S. Provisional Application Ser. No. 63/541,584, filed Sep. 29, 2023, which is incorporated herein by reference in its entirety.

### BACKGROUND

In the context of today's taxi services and ride sharing services, traditional vehicle routing systems focus on factors like travel time, traffic patterns, road conditions, and tolls when selecting the best route to a rider's specified destination or drop-off location. For example, a vehicle routing system may analyze historical traffic data to determine the quickest routes at the requested ride time, taking into account road conditions (e.g., road construction and improvement projects) and any major events that could impact traffic. These conventional routing systems may also account for tolls and fees along different possible routes to minimize costs. Additional factors like driver availability, vehicle capacity, and a rider's vehicle preferences may also be considered. The vehicle routing system will use algorithms and mapping data to compare the various route options given the rider's pick-up location and specified destination or drop-off location, and then select the optimal route and driver based on these factors.

In the not-too-distant future, significant technological advancements in specific areas such as sensor technologies, machine learning (e.g., computer vision algorithms), and related technology fields, are expected to usher in an era of self-driving cars. These self-driving vehicles, commonly known as autonomous vehicles (“AVs”), have the potential to revolutionize the way we interact with transportation, leading to a potential decrease in individual car ownership. Instead, it is anticipated that people will increasingly rely on robot vehicles or self-driving taxis for their transportation needs. The shift to autonomous vehicles for ride services opens up new opportunities to leverage advanced vehicle routing techniques that take into consideration factors that go beyond the conventional.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram illustrating an example of a computing environment in which an autonomous vehicle may be integrated to operate, consistent with some examples.

FIG. 2 is a diagram illustrating an example of a map showing multiple routes between a pick-up location and a drop-off location, where each route has been identified in response to receiving a ride request and each route is associated with one or more business entities that have partnered with an autonomous vehicle ride service to provide in-vehicle promotions (e.g., advertisements and offers), consistent with some examples.

FIG. 3 is a diagram illustrating an alternative view of the several routes shown within the map of FIG. 4, wherein each route includes various promotions having different bid values assigned, where each promotion is associated with a business entity having a place of business along the route, according to some examples.

FIG. 4 is a user interface diagram illustrating an example of a user interface for a mobile application, where the user interface is presenting route-based promotions to a rider, consistent with some examples.

FIG. 5 is a diagram illustrating an example of a map showing a route that starts at a requested pick-up location and ends at a requested drop-off location, and for which two route-based offers have been identified, consistent with some examples.

FIG. 6 illustrates an example of a user interface for presentation to a rider, where the user interface is presenting the two route-specific promotions, consistent with some examples.

FIG. 7 is a flow diagram illustrating various operations of a method for deriving a route for a network-connected autonomous vehicle, according to some examples.

FIG. 8 illustrates an example system including a host device and a storage device.

FIG. 9 illustrates a block diagram of an example machine upon which any one or more of the techniques discussed herein may perform.

### DETAILED DESCRIPTION

The present inventors have recognized, that the advent of self-driving technology will fundamentally change the experience of riding in a car. Without the need to operate the vehicle, passengers or riders will be free to spend their travel time on more productive or enjoyable activities. Reading, working, sleeping, dining, entertainment, and conversation are all options for recapturing time spent commuting or traveling. With this shift, passengers are likely to prioritize routes and experiences that maximize their ability to make use of the freed up time. Total travel distance and duration may become less important factors when selecting transportation options. Instead, riders may opt for routes that provide access to dining options, shopping opportunities, or scenic views. The vehicle routing services of the future will need to take into account these shifting priorities and focus on customizing routes and in-car experiences to enable passengers to truly utilize their recaptured commute time. Companies that leverage this change stand to provide substantial value to users through creative routing techniques. To that end, a vehicle routing service for an autonomous vehicle ride service is described herein.

Embodiments of the present invention relate to a system and method for selecting optimized routes for network-connected autonomous vehicles providing ride services, where the selection of an optimal route is based on business incentives and promotions. The system involves a ride service platform with a vehicle routing service that can identify multiple potential routes between a rider's pick-up and drop-off locations that satisfy basic time and distance requirements.

For each potential route, the vehicle routing service of the system determines an expected monetary value associated with the route based on promotions and incentives offered by businesses located near the route. Businesses can submit promotions via a promotion management platform that is integrated with the vehicle routing service. Each promotion includes a bid amount or bid value indicating what the business is willing to pay to have its promotion displayed to riders traveling on a route that passes near the business location.

The vehicle routing service of the ride service platform analyzes these promotions and bid amounts to calculate an overall expected monetary value for each route. The route with the highest expected value is selected and provided to the autonomous vehicle assigned to the ride.

During the ride, promotions associated with the high value route are presented to the rider via an in-vehicle display, or via the display of a mobile computing device of the rider. The rider can choose to interact with a promotion, for example by accept an offer or otherwise selecting an option to have the autonomous vehicle re-routed to a location (e.g., a place of business) associated with the promotion, resulting in the vehicle diverting from the original route, and stopping at the place of business. A mobile application provided by the ride service may be used by the rider to conclude a transaction associated with a promotion. The business incentives allow the ride service to guide riders along routes that are optimized based on financial and marketing considerations.

Another key capability of the system is the ability to identify and leverage new promotions that are submitted after a ride has already begun. The cloud-based vehicle routing service maintains a constant connection with the promotion management platform to receive updates on new promotions as soon as they are available. During an active ride, the vehicle routing service continues to monitor for compelling new promotions that may be relevant based on the vehicle's current route and proximity to the business. For sufficiently high-value promotions, the routing service can make real-time decisions to alter the existing route to a route that will pass by a place of business for which a promotion is available.

For example, if a coffee shop adds a new promotion with a high bid value, and the vehicle is within a short detour distance, the vehicle routing service may determine it is optimal to divert to the coffee shop to allow the rider to take advantage of the deal. The promotion is immediately displayed on the in-vehicle interface, and if accepted by the rider, the autonomous vehicle is routed to the place of business offering the promotion.

Another key aspect of the invention is how business entities can derive appropriate bid values for promotions to present to nearby riders. The bid value indicates how much the business is willing to pay the ride service to display the promotion to a rider when traveling near the business location. To optimize these bid values, businesses can utilize various techniques to analyze their current and projected capacity to serve additional customers that may be directed to the location based on a promotion. By linking bid values to capacity, businesses can maximize revenue opportunities when demand is low while avoiding overextending resources when capacity is strained.

For example, computer vision algorithms can assess real-time customer volume at a location using cameras and sensors. Point-of-sale systems can be configured with controls allowing staff to indicate current staffing levels, inventory, and daily sales targets. Inventory management software can provide live inventory availability. All of this data can be aggregated and fed into machine learning models that optimize bid pricing based on correlations between bid values, conversion rates, and revenue. The models learn to adjust bids automatically based on factors like foot traffic, wait times, staffing, inventory, and sales data.

This automated approach provides advantages for both riders and businesses compared to conventional vehicle routing techniques. Riders enjoy discounted offers and deals for nearby businesses dynamically promoted during their trip. Meanwhile, businesses can target riders at opportune times based on real-time operating conditions. The platform coordinates the parties for mutual benefit. By continuously evaluating new promotions, the system can dynamically adjust routes to maximize value for both riders and businesses. The real-time nature of the platform allows businesses to capitalize on short-term opportunities and capacity, while increasing convenience for riders. This on-the-fly promotion matching and re-routing capability provides advantages over conventional ride services. The system can react to emerging promotions and availability in a way that human drivers cannot. This maximizes revenue across the ride service ecosystem in a way that requires real-time automated decision-making. By leveraging these techniques, businesses can programmatically tune their bid values to align with their true capacity and objectives. This automated approach allows businesses to maximize the value of promotions displayed to nearby riders. The system delivers significant advantages over manual bid management. Other aspects and advantages of the various embodiments of the invention are described below in connection with the description of the figures.

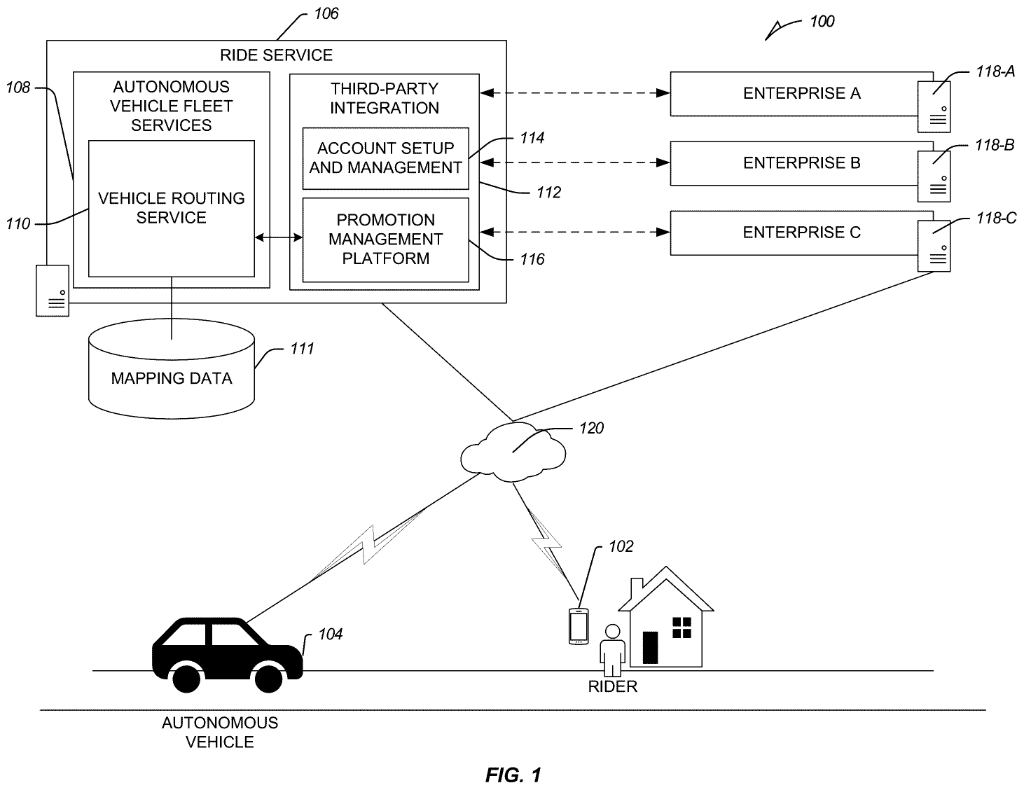

FIG. 1 is a diagram illustrating an example of a computing environment 100 in which an autonomous vehicle 104 may be integrated to operate, consistent with some examples. As shown in FIG. 1, a user or rider is operating a mobile computing device 102 that includes a mobile application for the ride service 106. The mobile computing device 102 represents a user device that allows a rider to request a ride from the autonomous vehicle ride service. Depicted as a mobile device (e.g., phone or smartphone) in FIG. 1, the mobile device 102 could also be a wearble device (e.g., a smart watch), a tablet, laptop, or any other computing device with networking capabilities. To request a ride, the rider utilizes an application or interface on the mobile device 102 to specify a pick-up location and a drop-off destination. This ride request is then transmitted over a network 120 to the cloud-based ride service 106.

The ride request will typically include key parameters such as the start point, end point, desired pick-up time, desired vehicle attributes, and rider identity information. The ride request may be sent wirelessly via a cellular network, WiFi network, or other wireless internet connectivity supported by the mobile device 102. By submitting the ride request via the mobile application on device 102, the rider triggers the automated routing and assignment process handled by the backend fleet services platform 108. The fleet services 108 will process the ride request and dispatch an autonomous vehicle 104 to the location of the rider, to fulfill the ride.

As shown in FIG. 1, the cloud-based ride service 106 includes a third-party integration component 112 that allows outside businesses and enterprises to interface with the ride service platform 106. This third-party integration component 112 provides each third-party with access to the promotion management platform 116. For instance, using the account setup and management component 114, a representative of a third-party enterprise or business, such as Enterprise A 118-A, Enterprise B 118-B, and Enterprise C 118-C, can establish a corporate account with the ride service. By setting up an account, an enterprise can access the promotion management platform 116 through a customized portal or user interface.

The portal or interface for the promotion management platform 116 allows authorized users at the enterprise to configure and manage promotions that will be presented to riders during autonomous vehicle trips. As used herein, a “promotion” refers generally to both advertisements and offers that may be presented to riders during an autonomous vehicle trip. An “advertisement” is a form of promotion that communicates information about a product, service, or brand without implying any particular offer or discount on a specific item. However, an “offer” is a form of promotion that directly prompts or incentivizes the rider to take a specific action, such as making a purchase, signing up for a service, claiming a discount, etc., typically in connection with a specific product or service. Promotions, advertisements, and offers may include textual, graphical, video, audio, or other multimedia content. For example, a coffee shop chain may create an account that marketing managers can use to submit coffee deals (e.g., offers) and advertisements targeted at riders as they travel near shop locations. The account setup process handles authentication, authorization, billing, and provisioning of access credentials for each enterprise user.

To set up a promotion, the user specifies promotional content including text, images, video, audio, etc., that will be displayed to riders. For example, an ice cream shop may create a promotion that shows a picture of a milkshake along with text describing a buy-one-get-one-free deal. The enterprise user also specifies a bid value which indicates the maximum amount the enterprise is willing to pay the ride service each time the promotion is shown to a rider, or in some instances, each time a rider accepts an offer or otherwise interacts with a promotion to temporarily re-route a vehicle to stop at a place of business. Higher bid values increase the likelihood of the promotion being selected and displayed. In addition, the enterprise user may set targeting parameters like geographic locations, times of day, rider demographics, etc. to control which riders will be eligible to receive the promotion.

In some examples, the promotion management platform interface allows previewing how a promotion will appear when presented to a rider. A promotion may be presented to a rider on an in-vehicle display, or alternatively, via a mobile application on the mobile computing device of the rider. Once finalized, the promotion can be activated and will then be evaluated by the vehicle routing service, and potentially displayed to riders that meet the configured targeting criteria. Usage analytics provide insight into how often the promotion has been displayed and any actions taken by riders. This allows the enterprise to monitor performance and optimize their promotions over time.

In some examples, the promotion management platform 116 allows enterprises to dynamically control the bid value associated with a promotion. Bid values can be configured based on a schedule or set to expire at a certain time. For more granular real-time control, consistent with some embodiments, an enterprise can connect their internal systems to the promotion management platform 116, for example, via an application programming interface (API). This allows programmatic updating of bid values from the enterprise side.

For example, an enterprise may connect their point-of-sale system and use data on current sales and customer volume to automatically tune the bid value. When demand is low, the bid can be automatically raised to attract more customers from the ride service. When demand is high, the bid can be lowered to reduce advertising spending. Machine learning algorithms can also be implemented to optimize bid pricing over time based on measured results and conversions from previous bid levels. The algorithms automatically adjust the bid value through the API connection. By facilitating both scheduled and real-time control of bid values, the promotion management platform 116 provides flexibility for enterprises. Each enterprise can define general rules and schedules, while still having the ability to dynamically adapt bids in real-time based on business needs. Automated and optimized bidding maximizes return on investment.

As shown in FIG. 1, the cloud-based ride service 106 includes autonomous vehicle fleet services 108, and specifically a vehicle routing service 110. In addition to the vehicle routing service 110, a variety of additional services (not shown) may be part of the fleet services 108. For example, the fleet services 108 may also include demand prediction algorithms to analyze historical ride data and external factors to forecast expected ride demand across locations and times of day. Vehicle diagnostic systems may monitor autonomous vehicle health and schedule proactive maintenance. Dispatch optimization algorithms may be included to efficiently assign and rebalance vehicles across a service region to meet demand. The fleet services 108 will also include billing systems, customer service interfaces, and rider assistance capabilities. Together these components enable robust management of the autonomous vehicle fleet to provide reliable and high-quality ride services.

Turning now to the vehicle routing service 110, when a ride request is received at the cloud-based ride service platform 106 from a rider's mobile device 102, the vehicle routing service 110 initially analyzes mapping data 111 to identify a default route using a first set of parameters and a first algorithm. The default route may be the fastest route to the rider's destination based on expected travel time. For instance, this route may be determined by analyzing factors like distance, traffic conditions, road conditions (e.g., road construction activity), speed limits, road tolls and fees, and so forth. In some examples, the first algorithm may identify the default route as the fastest route, taking into consideration all of the various factors set forth above.

Consistent with some embodiments, after identifying the default route, the vehicle routing service 110 then identifies a set of alternative routes that satisfy some condition. For instance, the alternative routes may be identified based on having expected travel times that are within a configurable threshold of the expected travel time for the default route. For example, the alternative routes may be selected based on having an expected travel time that is within some predetermined percentage of the travel time for the default route. For instance, in a scenario where the threshold is 120% of the expected travel time of the default route, if the default route has an expected travel time of 20 minutes, the vehicle routing service may select as alternative routes any route having an expected travel time that is equal to or less than 120% of 20 minutes, or 24 minutes. This threshold may differ for different expected travel time ranges. For example, a first threshold may be used for shorter rides, whereas a second threshold may be specified for longer rides.

Next, after determining the plurality of routes, the vehicle routing service 110 identifies any promotions that are associated with one of the several routes. In one example, the vehicle routing service 110 may send the set of initial route options as a request or query to the promotion management platform 116. This request or query includes the origin, destination, and potential routes for the trip. The promotion management platform 116 analyzes the routes and identifies all promotions from businesses that are proximate to any of the routes—that is, within some threshold distance. In some instances, this threshold distance may be predetermined and set as a system setting. However, in alternative implementations, the threshold distance may be a user profile setting, such that the threshold distance can be specified by a user as a configuration setting for the ride service. This allows the rider to establish some level of control over the routing service, so that the rider is not given longer than desired routes. In any case, the promotion management platform 116 returns information on these promotions back to the vehicle routing service 110.

In some embodiments, the vehicle routing service 110 may simply request from the promotion management platform 116 information relating to all promotions that are generally in the vicinity of a geographical area that encompasses all of the routes, and then the vehicle routing service will determine which promotions are within the threshold distance of a particular route.

With the routes now being associated with their respective promotions, the vehicle routing service 110 calculates a monetary value for each route based on the promotions associated with the route. More precisely, the monetary value of a route is based on the bid values for the promotions that are associated with the route. Additional factors like rider preferences, promotion relevance, business rules, etc. may be used to weight or adjust the values. The route with the highest monetary value is then selected as the trip route for the ride. This route offers the most potential value from serving promotions to the rider.

With the ride route now selected, information on the promotions affiliated with the selected route is provided to the autonomous vehicle 104. This allows the in-vehicle system to present those promotions to the rider over the course of the trip. In addition to communicating the selected route to the autonomous vehicle, to enable the vehicle to traverse the route, the selected route may also be communicated to the rider's computing device for informational purposes.

When a rider interacts with a promotion, for example, by selecting an in-vehicle button to accept an offer, or otherwise indicate a desire to be temporarily re-routed to a place of business associated with a promotion, the vehicle routing service 110 will communicate new routing information to the network-connected autonomous vehicle. In some examples, accepting a promotion via the user interface presented via the in-vehicle display will cause information to be communicated to an in-store order placement system, such that accepting of the promotion will invoke the in-store order. In this way, when the rider arrives to the place of business associated with the promotion, his or her order will have been prepared, eliminating wait time for the rider.

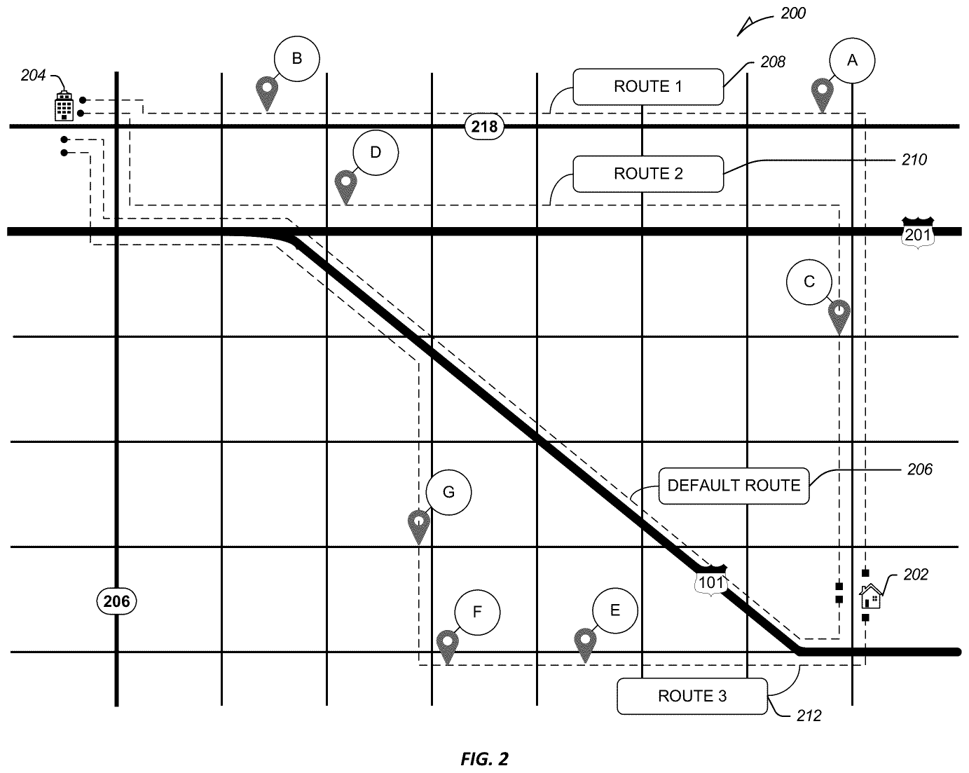

FIG. 2 is a diagram illustrating an example of a map 200 showing multiple routes between a pick-up location 202 and a drop-off location 204, where each route has been identified in response to receiving a ride request and each route is associated with one or more business entities that have partnered with an autonomous vehicle ride service to provide in-vehicle promotions, consistent with some examples. As shown in FIG. 2, a default route 206 is depicted that represents the fastest route between the pick-up location 202 and the drop-off location 204 based on expected travel time. This default route generally follows highway 101 as indicated on the map.

In addition to the default route 206, three alternative routes have been identified, labeled as “Route 1” 208, “Route 2” 210, and “Route 3” 212. Each of these three alternative routes begins at the pick-up location 202 and ends at the drop-off location 204.

Route 1 208 includes two promotions, one associated with the location labeled Å on the map and one associated with the location labeled B. Route 2 210 also includes two promotions, one associated with location C and one with location D. Finally, Route 3 212 includes three promotions associated with locations E, F, and G as marked on the map.

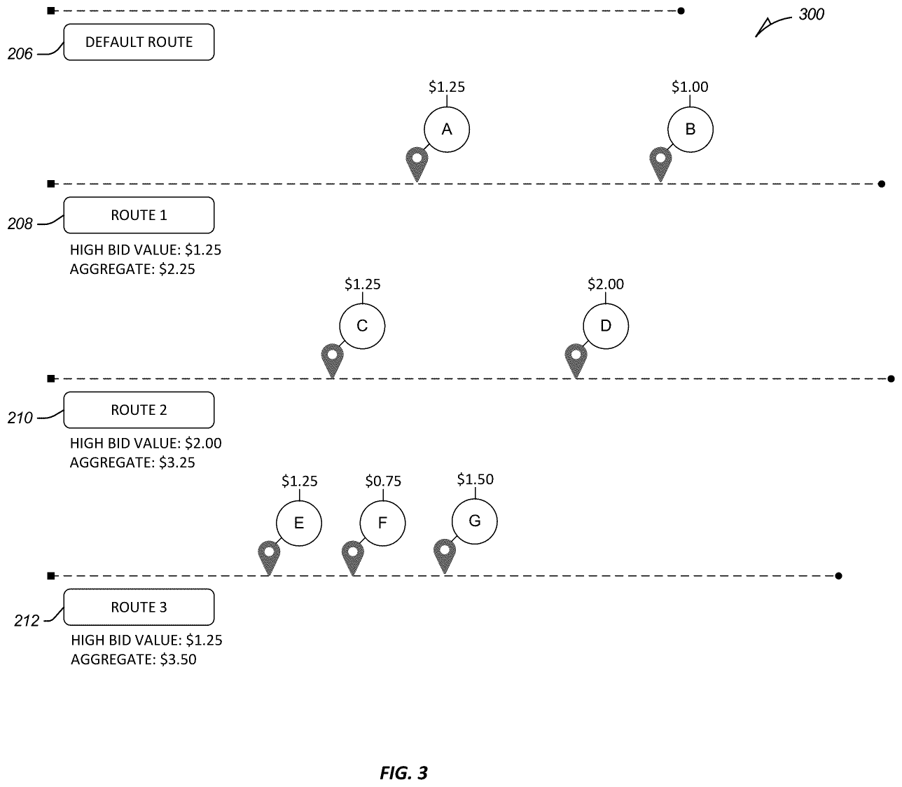

Accordingly, FIG. 2 illustrates how a vehicle routing service 110 identifies multiple route options between a requested pick-up and drop-off location, and further associates each potential route with promotions (e.g., offers and advertisements) from business entities located along or near the route. As described in FIG. 3, this allows calculation of an expected monetary value for each route.

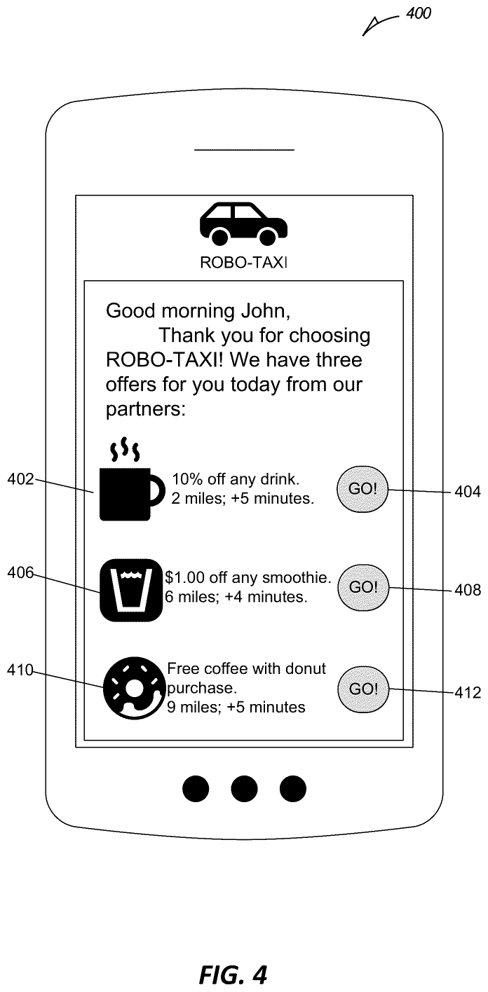

FIG. 3 is a diagram illustrating an alternative view of the several routes shown within the map of FIG. 4, wherein each route includes various promotions having different bid values assigned, and where each promotion is associated with a business entity having a place of business along the route, according to some examples. Given a plurality of routes leading from a requested pick-up location to a requested drop-off location, with each route being associated with various promotions having different bid values, there are a number of different techniques or algorithms that may be used to select a preferred ride route, consistent with embodiments of the present invention.

In some instances, the specific technique or algorithm used to select a route from the plurality of possible routes may depend on various factors, including how many promotions might be presented to a rider during a ride. For instance, if a requested ride exceeds some minimum distance or expected travel time threshold, it may be desirable to show the rider multiple promotions during the course of the ride. Consequently, in this case, it may be desirable to consider the bid values of multiple promotions associated with a route. However, on a ride that is short in time and/or distance, there may not be sufficient time to justify presenting the rider with multiple promotions. In this case, it may be more beneficial to select a route based on a promotion with the highest overall bid value, or a promotion with the highest scored bid value, where the scoring of the bid value takes into account considerations impacting the likelihood of the rider to re-route a vehicle in view of a promotion that is presented. Some of the various techniques for selecting a route are set forth below.

A first technique involves selecting a route from the several possible routes based on the selected route having a promotion with the single highest bid value amongst all promotions. This involves identifying for each route the promotion having the highest bid value, and then selecting the route with the one promotion that has the highest bid value, in comparison with the high bid value of the other routes.

With reference to FIG. 3, using the first technique, the vehicle routing service would analyze each route and identify the promotion with the highest bid value. For Route 1 208, Promotion A has the greater bid value at $1.25 compared to Promotion B at $1.00. For Route 2 210, Promotion D has the higher bid value at $2.00 versus Promotion C at $1.25. Finally, for Route 3 212, Promotion G has the greatest bid value at $1.50, higher than Promotions E and F at $1.25 and $0.75 respectively. Comparing the highest bid values across routes, Promotion D on Route 2 210 has the single highest bid amount at $2.00. Therefore, using the first technique focused solely on the maximum bid value, Route 2 would be selected by the vehicle routing service since it provides access to Promotion D with the highest bid amount of $2.00. This route offers the greatest potential revenue. During the ride, Promotion D would be presented to the rider on the in-vehicle system.

A second technique involves aggregating or combining the bid values for all promotions associated with a potential route. For example, the bid amounts for all promotions for a given route could be summed, or an average could be calculated. Using this aggregate bid value, the route with the highest overall combined value is selected.

Applying this to the example, Route 1 208 has a total combined bid value of $1.25+$1.00=$2.25. Route 2 has a total of $1.25+$2.00=$3.25. Finally, Route 3 has a total of $1.25+$0.75+$1.50=$3.50. Comparing the aggregate values, Route 3 has the highest total bid amount of $3.50. Therefore, using this second technique of aggregating all bid values for a route, the vehicle routing service would select Route 3 since it has the highest total combined bid value from Promotions E, F, and G. This route overall offers the most revenue potential from the multiple promotions available. During the ride, Promotions E, F, and G would be presented to the rider.

A third approach involves generating a score for each promotion, where the score represents a measure of likelihood of the rider taking action to re-route the vehicle to a specific place of business, in response to a specific promotion being presented during the trip. This score can then be used to weight the bid value in determining an overall route valuation. To calculate the score, the vehicle routing service can analyze data from the rider's profile and historical usage patterns. For example, any explicit preferences like favorite stores, favorite shops, favorite food and drinks, and interests, as provided in a user profile, can indicate probability of accepting related offers. If a rider lists coffee shops as an interest or favorite drink, promotions from coffee shops could receive a higher score. Historical acceptance rates for similar types of offers can inform the score. If the rider frequently accepts coffee offers, new coffee offers will be scored higher. Demographic data like age, location, and gender can factor into aggregate acceptance rates that feed into the score. Any past interactions the specific rider has had with the business or offer can greatly influence the score. Previous redemptions or engagements with the promotion would increase the score.

In some examples, the score may be generated as a numeric value between 0 and 1 indicating the probability of acceptance by the rider. For example, a score of 0.9 indicates a 90% likelihood the rider will interact with the promotion if presented. To select a route, the vehicle routing service multiplies each bid value by the rider acceptance score. Once the bid value for each promotion has been scored, the route service may select the route having the promotion with the single highest scored bid value. Alternatively, the resulting weighted bid amounts may be aggregated for each route and the route with the highest total weighted bid value is selected, as it has the greatest expected revenue. This approach allows the rider's preferences and past behaviors to influence the route selection through the personalized scores. The bid amounts are weighted by the probability the rider will engage with each promotion.

Another approach to selecting a route from amongst the possible routes involves leveraging machine learning algorithms to predict the likelihood a rider will accept each promotion. A supervised learning model can be trained on historical data and then used to score new promotions. The training data would include past examples of riders receiving offers, along with labels indicating if they accepted or not. Features fed into the model can include:
Rider profile data like demographics and interests
Historical acceptance rates for similar offers
Time, location, and trip details
Promotion details like product, discount, business, etc.

A classification algorithm like logistic regression or random forest may be trained on this data. The output may be an acceptance probability score between 0 and 1. For a new ride, the trained model takes in the rider and promotion details as input features and outputs an acceptance score for each promotion. These scores are then used to weight the bid values, as in the third approach, described above. The weighted totals may be aggregated per route to select the route with the maximum expected revenue based on predicted rider engagement with the promotions. This machine learning approach allows the scoring and weighting process to become more sophisticated and personalized as more rider data is collected over time. The model can adapt to changing trends and keep improving route selection optimization.

Consistent with some embodiments, business rules may be incorporated to filter and diversify the promotions considered in the route selection techniques:
Promotion diversity rules can ensure riders are presented with a variety of offers. For example, if multiple promotions relate to coffee shops, all but the highest value coffee shop promotion could be excluded.
Proximity filters can remove duplicate promotions from nearby locations. If two promotions are from businesses in close proximity, the lower value one (e.g., bid value) may be removed.
Time limitations can filter promotions outside of a rider's trip duration or the business's active hours.
Inventory or capacity thresholds from businesses can filter promotions when supply is low.
Promotions can be excluded if they have been shown to the rider recently, to avoid oversaturation.
Businesses may designate rules to only show a promotion to new customers who have not received it before.
Rules can help spread promotions evenly across geographic regions or trip types.
Advertisements from direct competitors could be blocked from appearing together.

The vehicle routing service may apply these rules when selecting promotions to associate with each potential route. These rules help curate the set of promotions considered during the route optimization process. This ensures a better overall rider experience with useful, diverse offers.

FIG. 4 illustrates an example user interface 400 of a mobile application provided by the autonomous vehicle ride service. The interface 400 is presenting three different route-based offers to the rider during an active trip. The first offer 402 shown is “10% off any drink” from a coffee shop. The distance to the coffee shop is shown as 2 miles, and accepting the offer would add 5 minutes to the overall ride time. A “GO!” button 404, when selected, allows the rider to accept the offer and have the autonomous vehicle reroute to stop at the coffee shop.

The second offer 406 is “$1.00 off any smoothie” from a smoothie shop. The distance to the smoothie shop is shown as 6 miles and it would add 4 minutes to reroute there. Again, a “GO!” 408 button allows one-touch acceptance by the rider.

The third offer is “Free coffee with donut purchase” 410 from a donut shop. The distance is 9 miles and would add 5 minutes to the trip time. A “GO!” button enables accepting this offer as well.

This mobile interface 400 allows the rider to view route-based offers in real-time during a ride. The additional distance and time for each detour is displayed. With one tap on the “GO!” button, the rider can agree to the detour and claim the offer. This causes the routing service to update the route to the selected location. The interface provides an easy way for riders to discover and redeem offers from businesses along their route. The businesses compensate the ride service when offers are redeemed to offset added trip time and distance.

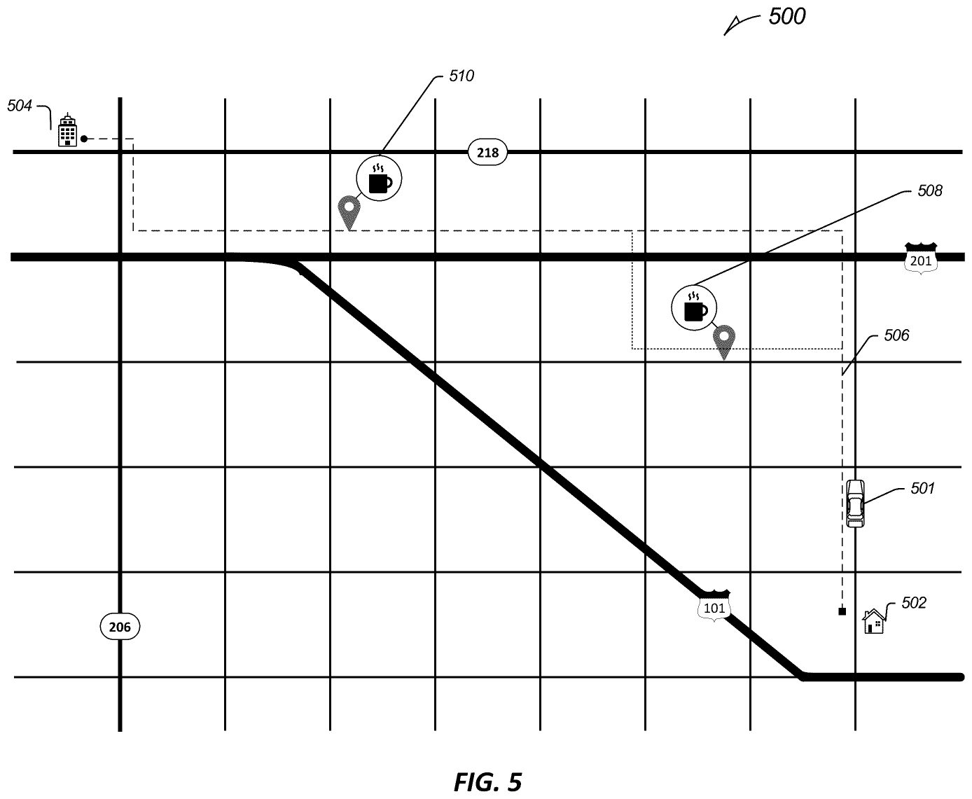

FIG. 5 is a map diagram 500 illustrating the ability of the vehicle routing service to identify and leverage new promotions that arise even after a ride has begun and a route 506 is in progress. The map 500 shows an autonomous vehicle 501 already traveling along a route 506 between the rider's pick-up location 502 and destination 504. At the time this initial route 506 was selected by the routing service, there were no active promotions. However, during the ride, a coffee shop company added two new promotions-one for their Main Street location 508, and one for their West End location 510. Because the vehicle routing service is continuously connected to the promotion management platform, this allows the routing service to immediately identify these new promotions when they become available. Even when a trip is already underway, the routing service evaluates whether either of the new promotions are compelling enough to justify presenting to the rider, and possibly dynamically changing the existing route. By monitoring for and reacting to emerging promotions in real-time, the system can maximize revenue across the entire duration of a ride. The autonomous vehicle can divert to a new location mid-trip if a high-value promotion arises that warrants a route change. This on-the-fly promotion matching and re-routing capability provides advantages over conventional static ride services by responding fluidly to new opportunities.

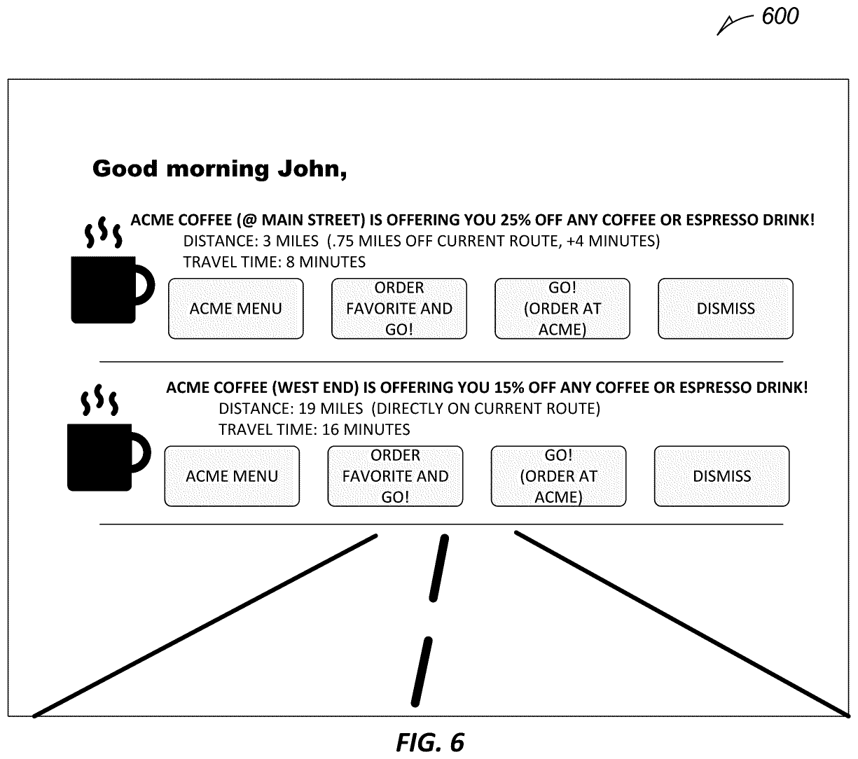

FIG. 6 illustrates an example of a user interface for presentation to a rider, where the user interface is presenting the two route-specific advertisements or offers as shown in the map of FIG. 5, consistent with some examples. The interface displays the offer details along with interactive buttons allowing the rider to engage with the promotion. This interface may, for example, be presented on an in-vehicle touch screen display. Although not illustrated in connection with FIG. 6, in some instances, a promotion may include dynamic content, including video clips, audio, and so forth.

The first offer 602 is from the Acme Coffee location on Main Street. It provides 25% off any coffee or espresso drink. The distance of 3 miles and travel time of 8 minutes are displayed. Four selectable buttons are provided:
“Acme Menu”-Displays the menu from this Acme Coffee shop.
“Order Favorite and Go!”-Allows the rider to place a remote order for a favorite pre-set item and navigate directly to the shop.
“Go!”-Accepts the offer and reroutes the vehicle to the shop.
“Dismiss”-Closes the offer display.

The second offer 604 is from the Acme Coffee on West End. This location provides 15% off any coffee drink. The distance is 19 miles with a travel time of 16 minutes. This second offer contains the same four selectable buttons as the first offer. This allows the rider to view the unique menu, order in advance, reroute to the shop, or dismiss.

Consistent with some embodiments, an in-store computing system at a business location may continuously monitor in real-time customer volume, orders, and staffing levels. Using this data, an algorithm may predict expected wait times at different times of day, for example, a 10-minute wait during peak lunch hours. This information is transmitted to the promotion management platform via an API integration. Accordingly, when creating a promotion, the business can configure whether to include live wait time estimates, or not. When the promotion is displayed to riders, the additional route travel time may be combined with the current predicted wait time. So, a promotion might show “Add 8-minute drive time+10 minute wait for a total of 18 additional minutes.” If a rider accepts the offer, the routing service will factor the total additional time into the updated route. As the autonomous vehicle approaches the place of business, the ride service mobile app provides updated wait time estimates based on the latest data from the in-store system. This allows riders to make informed decisions accounting for both travel time and wait time when considering a promotion.

By monitoring for compelling new promotions, the routing service empowers riders to capitalize on emerging offers that align with their interests and preferences. The interactive interface promotes convenience and maximizes the likelihood of offer redemptions, while providing information up front about expected wait times.

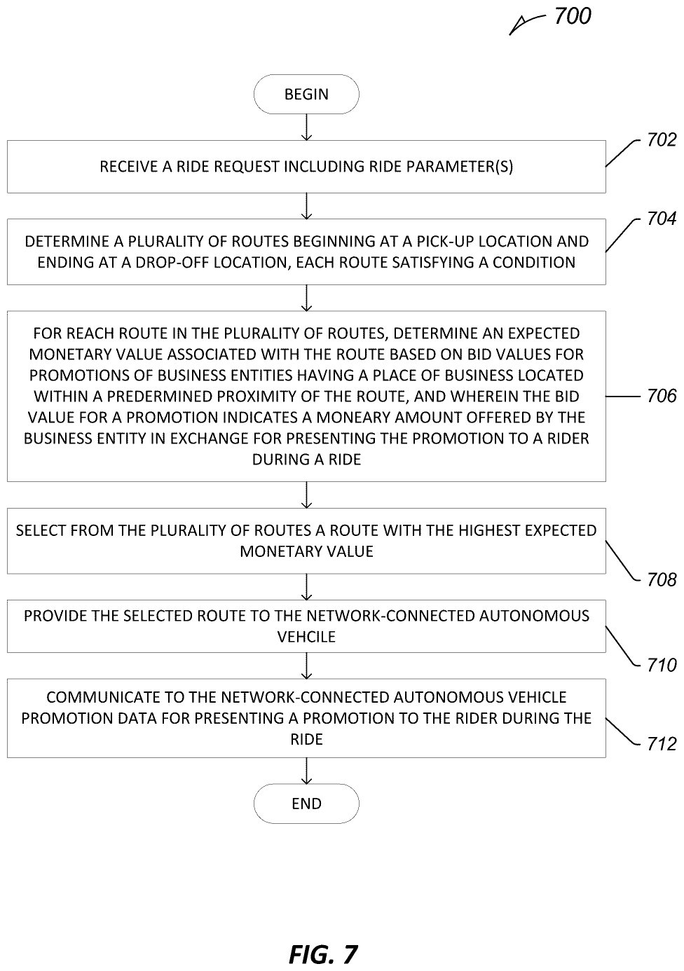

FIG. 7 is a flow diagram illustrating various operations of a method for deriving a route for a network-connected autonomous vehicle, according to some examples. At method operation 702, a ride request is received for processing at the vehicle routing service. The ride request may specify a variety of ride parameters, including a pick-up time and location, as well as a final destination or drop-off location. In many instances, the ride request may be received from a mobile device of a rider. However, it is also possible that a rider may, for example, enter a parked car and use the in-vehicle touchscreen display to generate the ride request. In any case, the ride request is transmitted over a network to the cloud-based ride service platform, where it will be processed by the vehicle routing service.

Next, at method operation 704, the vehicle routing service analyzes mapping data to identify a plurality of routes beginning at the requested pick-up location and ending at the requested drop-off location. TO identify the plurality of routes, the vehicle routing service may first identify a default fastest route based on expected travel time. The vehicle routing service may then identify alternative routes that have expected travel times within a configurable threshold of the default route's expected travel time (e.g., within 15% longer). The configurable threshold may be specified as a fixed value, or as a percentage, either of which may vary based on expected travel time. For example, consider a default route with an expected travel time of 10 minutes. With some embodiments, the configurable threshold may be determined for all rides between 5 and 15 minutes in expected travel time to be 10 minutes greater than the expected travel time. Accordingly, any route that has an expected travel time of 20 minutes (i.e., 10 minutes for the expected travel time of the default route+10 minutes for the configurable threshold) may be included in the plurality of possible routes.

At method operation 706, promotion data for any currently active promotion associated with a business location proximate to one of the several possible routes is obtained. For example, the routing service queries the promotion management platform to get data relating to promotions that are associated with locations (e.g., places of business) near each potential route.

Next, at method operation 708, the routing service calculates an expected monetary value for each route in the plurality of possible routes. The expected monetary value of a route is based on the bid values of the associated promotions for the route. Additional factors like rider preferences may be used to adjust the bid values, and ultimately the expected monetary value of the route.

Although not shown in FIG. 7, the bid value for a promotion may be automatically derived by an in-store computing device that maintains a constant network connection with the promotion management platform. Accordingly, the bid value of a promotion may be derived based on various business interests of the enterprise providing the promotion. For example, current staffing levels may impact the automatically determined bid value. A comparison of actual receipts to expected receipts may impact the bid value. Similarly, inventory levels, observed customer flow, and expected wait times may impact the bid value of a promotion.

At method operation 710, a route, in the plurality of possible routes, having the highest expected monetary value is selected. The route with the maximum expected revenue potential is chosen as it offers the most value from serving promotions to riders.

At method operation 712, the selected route is supplied to the network-connected autonomous vehicle so the vehicle can navigate the route.

Finally, at method operation 714, promotion data for promotions associated with the route is also transmitted to the autonomous vehicle (and, possibly to the mobile app for the ride service) so that the promotions can be presented to the rider during the trip. Promotion content is displayed to the rider on in-vehicle screens. The rider can choose to engage with promotions, causing the vehicle to dynamically re-route to a place of business associated with a promotion.

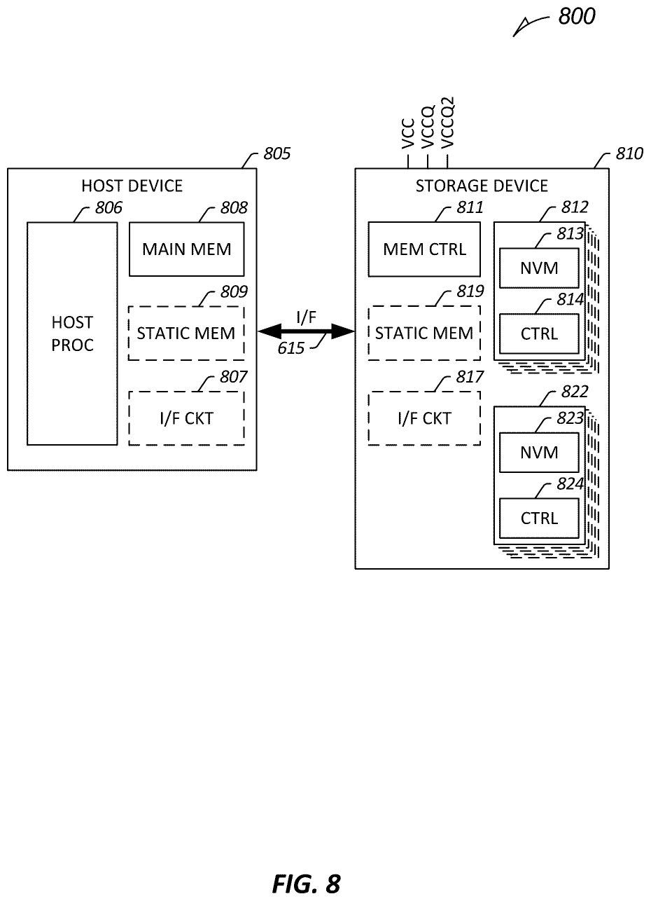

FIG. 8 illustrates an example system 800 (e.g., a host system or processor system) including a host device 805 and a storage device 810 configured to communicate over a communication interface (I/F) 815 (e.g., a bidirectional parallel or serial communication interface). In an example, the communication interface 815 can be referred to as a host interface. The host device 805 can include a host processor 806 (e.g., a host central processing unit (CPU) or other processor or processing circuitry, such as a memory management unit (MMU), interface circuitry, etc.). In certain examples, the host device 805 can include a main memory (MAIN MEM) 808 (e.g., DRAM, etc.) and optionally, a static memory (STATIC MEM) 809, to support operation of the host processor (HOST PROC) 806.

The storage device 810 can include a non-volatile memory device, in certain examples, a single device separate from the host device 605 and components of the host device 805 (e.g., including components illustrated in FIG. 8), in other examples, a component of the host device 805, and in yet other examples, a combination of separate discrete components. For example, the communication interface 815 can include a serial or parallel bidirectional interface, such as defined in one or more Joint Electron Device Engineering Council (JEDEC) standards.

The storage device 810 can include a memory controller (MEM CTRL) 811 and a first non-volatile memory device 812. The memory controller 811 can optionally include a limited amount of static memory 819 (or main memory) to support operations of the memory controller 811. In an example, the first non-volatile memory device 812 can include a number of non-volatile memory devices (e.g., dies or LUNs), such as one or more stacked flash memory devices (e.g., as illustrated with the stacked dashes underneath the first non-volatile memory device 812), etc., each including non-volatile memory (NVM) 813 (e.g., one or more groups of non-volatile memory cells) and a device controller (CTRL) 814 or other periphery circuitry thereon (e.g., device logic, etc.), and controlled by the memory controller 811 over an internal storage-system communication interface (e.g., an Open NAND Flash Interface (ONFI) bus, etc.) separate from the communication interface 815. Control circuitry, as used herein, can refer to one or more of the memory controller 811, the device controller 814, or other periphery circuitry in the storage device 810, the NVM device 812, etc.

Flash memory devices typically include one or more groups of one-transistor, floating gate (FG) or replacement gate (RG) (or charge trapping) storage structures (memory cells). The memory cells of the memory array are typically arranged in a matrix. The gates of each memory cell in a row of the array are coupled to an access line (e.g., a word line). In NOR architecture, the drains of each memory cell in a column of the array are coupled to a data line (e.g., a bit line). In NAND architecture, the drains of each memory cell in a column of the array are coupled together in series, source to drain, between a source line and a bit line.

Each memory cell in a NOR, NAND, 3D XPoint, FeRAM, MRAM, or one or more other architecture semiconductor memory array can be programmed individually or collectively to one or a number of programmed states. A single-level cell (SLC) can represent one bit of data per cell in one of two programmed states (e.g., 1 or 0). A multi-level cell (MLC) can represent two or more bits of data per cell in a number of programmed states (e.g., 2n, where n is the number of bits of data). In certain examples, MLC can refer to a memory cell that can store two bits of data in one of 4 programmed states. A triple-level cell (TLC) can represent three bits of data per cell in one of 8 programmed states. A quad-level cell (QLC) can represent four bits of data per cell in one of 16 programmed states. In other examples, MLC can refer to any memory cell that can store more than one bit of data per cell, including TLC and QLC, etc.

In three-dimensional (3D) architecture semiconductor memory device technology, memory cells can be stacked, increasing the number of tiers, physical pages, and accordingly, the density of memory cells in a memory device. Data is often stored arbitrarily on the storage system as small units. Even if accessed as a single unit, data can be received in small, random 4-16 k single file reads (e.g., 60%-80% of operations are smaller than 16 k). It is difficult for a user and even kernel applications to indicate that data should be stored as one sequential cohesive unit. File systems are typically designed to optimize space usage, and not sequential retrieval space.

The memory controller 811, separate from the host processor 806 and the host device 805, can receive instructions from the host device 805, and can communicate with the first non-volatile memory device 812, such as to transfer data to (e.g., write or erase) or from (e.g., read) one or more of the memory cells of the first non-volatile memory device 812. The memory controller 811 can include, among other things, circuitry or firmware, such as a number of components or integrated circuits. For example, the memory controller 811 can include one or more memory control units, circuits, or components configured to control access across the memory array and to provide a translation layer between the host device 805 and the storage system 800, such as a memory manager, one or more memory management tables, etc.

In an example, the storage device 810 can include a second non-volatile memory device 822, separate from the first non-volatile memory device 812, the second non-volatile memory device 822 can include a number of non-volatile memory devices, etc., each including non-volatile memory 823 and a device controller 824 or other periphery circuitry thereon, and controlled by the memory controller 811 over an internal storage-system communication interface separate from the communication interface 815. In an example, the first non-volatile memory device 812 can be configured as a “cold tier” memory device and the second non-volatile memory device 822 can be configured as a “warm tier” memory device (while the main memory 808, the static memory 809, the static memory 819 (or main memory) can be configured as a “hot tier” memory).

The memory manager can include, among other things, circuitry or firmware, such as a number of components or integrated circuits associated with various memory management functions, including, among other functions, wear leveling (e.g., garbage collection or reclamation), error detection or correction, block retirement, or one or more other memory management functions. The memory manager can parse or format host commands (e.g., commands received from the host device 805) into device commands (e.g., commands associated with operation of a memory array, etc.), or generate device commands (e.g., to accomplish various memory management functions) for the device controller 814 or one or more other components of the storage device 810.

The memory manager can include a set of management tables configured to maintain various information associated with one or more component of the storage device 810 (e.g., various information associated with a memory array or one or more memory cells coupled to the memory controller 811). For example, the management tables can include information regarding block age, block erase count, error history, or one or more error counts (e.g., a write operation error count, a read bit error count, a read operation error count, an erase error count, etc.) for one or more blocks of memory cells coupled to the memory controller 811. In certain examples, if the number of detected errors for one or more of the error counts is above a threshold, the bit error can be referred to as an uncorrectable bit error. The management tables can maintain a count of correctable or uncorrectable bit errors, among other things. In an example, the management tables can include translation tables or a L2P mapping.

The memory manager can implement and use data structures to reduce storage device 810 latency in operations that involve searching L2P tables for valid pages, such as garbage collection. To this end, the memory manager is arranged to maintain a data structure (e.g., table region data structure, tracking data structure, etc.) for a physical block. The data structure includes indications of L2P mapping table regions, of the L2P table. In certain examples, the data structure is a bitmap (e.g., a binary array). In an example, the bitmap includes a bit for each region of multiple, mutually exclusive, regions that span the L2P table.

The first non-volatile memory device 812 or the non-volatile memory 813 (e.g., one or more 3D NAND architecture semiconductor memory arrays) can include a number of memory cells arranged in, for example, a number of devices, planes, blocks, physical pages, super blocks, or super pages. As one example, a TLC memory device can include 18,592 bytes (B) of data per page, 1536 pages per block, 548 blocks per plane, and 4 planes per device. As another example, an MLC memory device can include 18,592 bytes (B) of data per page, 1024 pages per block, 548 blocks per plane, and 4 planes per device, but with half the required write time and twice the program/erase (P/E) cycles as a corresponding TLC memory device. Other examples can include other numbers or arrangements. A super block can include a combination of multiple blocks, such as from different planes, etc., and a window can refer to a stripe of a super block, typically matching a portion covered by a physical-to-logical (P2L) table chunk, etc., and a super page can include a combination of multiple pages.

The term “super” can refer to a combination or multiples of a thing or things. For examples, a super block can include a combination of blocks. If a memory device includes 4 planes, a super block may refer to the same block on each plane, or a pattern of blocks across the panes (e.g., a combination of block 0 on plane 0, block 1 on plane 1, block 2 on plane 2, and block 3 on plane 3, etc.). In an example, if a storage system includes multiple memory devices, the combination or pattern of blocks can extend across the multiple memory devices. The term “stripe” can refer to a pattern of combination or pattern of a piece or pieces of a thing or things. For example, a stripe of a super block can refer to a combination or pattern of pages from each block in the super block.

In operation, data is typically written to or read from the storage device 810 in pages and erased in blocks. However, one or more memory operations (e.g., read, write, erase, etc.) can be performed on larger or smaller groups of memory cells, as desired. For example, a partial update of tagged data from an offload unit can be collected during data migration or garbage collection to ensure it was re-written efficiently. The data transfer size of a memory device is typically referred to as a page, whereas the data transfer size of a host device is typically referred to as a sector. Although a page of data can include a number of bytes of user data (e.g., a data payload including a number of sectors of data) and its corresponding metadata, the size of the page often refers only to the number of bytes used to store the user data. As an example, a page of data having a page size of 4 kB may include 4 kB of user data (e.g., 8 sectors assuming a sector size of 512 B) as well as a number of bytes (e.g., 32 B, 54 B, 224 B, etc.) of auxiliary or metadata corresponding to the user data, such as integrity data (e.g., error detecting or correcting code data), address data (e.g., logical address data, etc.), or other metadata associated with the user data.

Different types of memory cells or memory arrays can provide for different page sizes or may require different amounts of metadata associated therewith. For example, different memory device types may have different bit error rates, which can lead to different amounts of metadata necessary to ensure integrity of the page of data (e.g., a memory device with a higher bit error rate may require more bytes of error correction code (ECC) data than a memory device with a lower bit error rate). As an example, an MLC NAND flash device may have a higher bit error rate than a corresponding SLC NAND flash device. As such, the MLC device may require more metadata bytes for error data than the corresponding SLC device.

In an example, the data in a chunk or data unit can be managed in an optimized manner throughout its tenure on the storage system. For example, the data is managed as one unit during data migration (e.g., garbage collection, etc.) such that the efficient read/write properties are preserved as data is moved to its new physical location on the storage system. In certain examples, the only limit to the number of chunks, data units, or blocks configurable for storage, tagging, etc., are the capacities of the system.

One or more of the host device 805 or the storage device 810 can include interface circuitry, such as a host interface circuit (I/F CKT) 807 or a storage interface circuit (I/F CKT) 817, configured to enable communication between components of the host system 800. Each interface circuit can include one or more interconnect layers, such as mobile industry processor interface (MIPI) Unified Protocol (UniPro) and M-PHY layers (e.g., physical layers), including circuit components and interfaces. The M-PHY layer includes the differential transmit (TX) and receive (RX) signaling pairs (e.g., DIN_t, DIN_c and DOUT_t, DOUT_c, etc.). In certain examples, the host interface circuit 807 can include a controller (e.g., a UFS controller), a driver circuit (e.g., a UFS driver), etc. Although described herein with respect to the UniPro and M-PHY layers, one or more other set of circuit components or interfaces can be used to transfer data between circuit components of the host system 800.

Components of the host system 800 can be configured to receive or operate using one or more host voltages, including, for example, VCC, VCCQ, and, optionally, VCCQ2. In certain examples, one or more of the host voltages, or power rails, can be managed or controlled by a power management integrated circuit (PMIC). In certain examples, VCC can be a first supply voltage (e.g., 2.7V-3.3V, 1.7V-1.95V, etc.). In an example, one or more of the static memory 819 or the non-volatile memory devices 812 can require VCC for operation. VCCQ can be a second supply voltage, lower than the VCC (e.g., 1.1V-1.3V, etc.). In an example, one or more of the memory controller 811, the communication interface 615, or memory I/O or other low voltage blocks can optionally require VCCQ for operation. VCCQ2 can be a third supply voltage between VCC and VCCQ (e.g., 1.7V-1.95V, etc.). In an example, one or more of the memory controller 811 of the communication interface, or other low voltage block can optionally require VCCQ2. Each host voltage can be set to provide voltage at one or more current levels, in certain examples, controllable by one or more device descriptors and levels (e.g., between [0:15], each representing a different maximum expected source current, etc.).

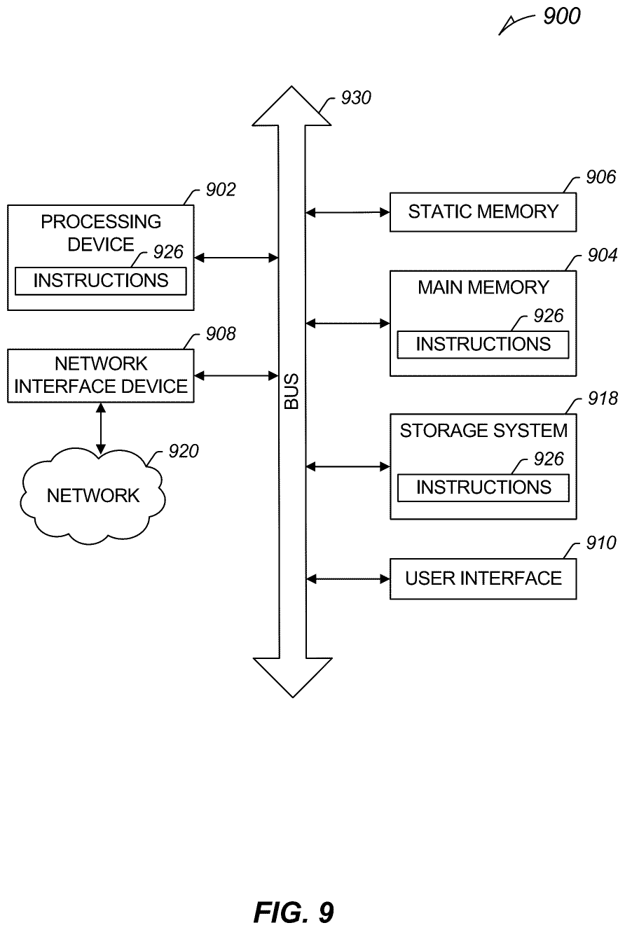

FIG. 9 illustrates a block diagram of an example machine 900 (e.g., a host system) upon which any one or more of the techniques (e.g., methodologies) discussed herein may perform. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may function as a peer machine in peer-to-peer (P2P) (or other distributed) network environment. The machine 900 may be a personal computer (PC), a tablet PC, a set-top box (STB), a personal digital assistant (PDA), a mobile telephone, a web appliance, an loT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 900 (e.g., computer system, a host system, etc.) may include a processing device 902 (e.g., a hardware processor, a central processing unit (CPU), a graphics processing unit (GPU), a hardware processor core, or any combination thereof, etc.), a main memory 904 (e.g., read-only memory (ROM), dynamic random-access memory (DRAM), a static memory 906 (e.g., static random-access memory (SRAM), etc.), and a storage system 918, some or all of which may communicate with each other via a communication interface 930 (e.g., a bus).

The processing device 902 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 902 can also be one or more special-purpose processing devices such as an application specific integrated circuit (ASIC), a field programmable gate array (FPGA), a digital signal processor (DSP), network processor, or the like. The processing device 902 can be configured to execute instructions 926 for performing the operations and steps discussed herein. The machine 900 can further include a network interface device 908 to communicate over a network 920.

The storage system 918 can include a machine-readable storage medium (also known as a computer-readable medium) on which is stored one or more sets of instructions 926 or software embodying any one or more of the methodologies or functions described herein. The instructions 926 can also reside, completely or at least partially, within the main memory 904 or within the processing device 902 during execution thereof by the machine 900, the main memory 904 and the processing device 902 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 900 may further include a user interface 910, such as one or more of a display unit, an alphanumeric input device (e.g., a keyboard), and a user interface (UI) navigation device (e.g., a mouse), etc. In an example, one or more of the display unit, the input device, or the UI navigation device may be a touch screen display. The machine a signal generation device (e.g., a speaker), or one or more sensors, such as a global positioning system (GPS) sensor, compass, accelerometer, or one or more other sensor. The machine 700 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 926 (e.g., software, programs, an operating system (OS), etc.) or other data are stored on the storage system 918 can be accessed by the main memory 904 for use by the processing device 902. The main memory 904 (e.g., DRAM) is typically fast, but volatile, and thus a different type of storage than the storage system 918 (e.g., an SSD), which is suitable for long-term storage, including while in an “off” condition. The instructions 926 or data in use by a user or the machine 900 are typically loaded in the main memory 904 for use by the processing device 902. When the main memory 904 is full, virtual space from the storage system 918 can be allocated to supplement the main memory 904; however, because the storage system 918 device is typically slower than the main memory 904, and write speeds are typically at least twice as slow as read speeds, use of virtual memory can greatly reduce user experience due to storage system latency (in contrast to the main memory 904, e.g., DRAM). Further, use of the storage system 918 for virtual memory can greatly reduce the usable lifespan of the storage system 918.

The instructions 924 may further be transmitted or received over a network 920 using a transmission medium via the network interface device 908 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi, IEEE 802.16 family of standards known as WiMax), IEEE 802.15.4 family of standards, peer-to-peer (P2P) networks, among others. In an example, the network interface device 908 may include one or more physical jacks (e.g., Ethernet, coaxial, or phone jacks) or one or more antennas to connect to the network 920. In an example, the network interface device 908 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as examples. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

As used herein, directional adjectives, such as horizontal, vertical, normal, parallel, perpendicular, etc., can refer to relative orientations, and are not intended to require strict adherence to specific geometric properties, unless otherwise noted. It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can be either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

As used in any embodiment herein, the term “logic” may refer to firmware or circuitry configured to perform any of the aforementioned operations. Firmware may be embodied as code, instructions or instruction sets, as data hard-coded (e.g., nonvolatile) in memory devices or circuitry, or combinations thereof.

“Circuitry,” as used in any embodiment herein, may comprise, for example, any combination or permutation of hardwired circuitry, programmable circuitry, state machine circuitry, logic, or firmware that stores instructions executed by programmable circuitry. The circuitry may be embodied as an integrated circuit, such as an integrated circuit chip. In some embodiments, the circuitry may be formed, at least in part, by the processor circuitry executing code or instruction sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture.

### Examples

Example 1 is a system for selecting a route for a network-connected autonomous vehicle, the system comprising: a processor; and a memory storage device storing executable instructions thereon, which, when executed by the processor, cause the system to perform operations comprising: receiving a ride request indicating a pick-up location and a drop-off location; determining a plurality of routes beginning at the pick-up location and ending at the drop-off location, each route in the plurality of routes satisfying a condition; for each route in the plurality of routes, determining an expected monetary value associated with the route, wherein the expected monetary value is based on bid values for promotions of business entities having a place of business located within a predetermined proximity of the route, and wherein the bid value for a promotion indicates a monetary amount offered by the business entity in exchange for presenting the promotion to a rider during a ride; selecting from the plurality of routes the route with the highest expected monetary value; and providing the selected route to the network-connected autonomous vehicle.

In Example 2, the subject matter of Example 1 includes, wherein the condition is that an expected travel time of the route does not exceed an expected travel time of a default route by more than a threshold amount, the default route determined to be the fastest route.

In Example 3, the subject matter of Examples 1-2 includes, wherein determining the expected monetary value associated with the route comprises: identifying promotions associated with business entities having a place of business located within the predetermined proximity of the route; for each identified promotion, retrieving the bid value associated with presenting the promotion to a rider; and aggregating the bid values for the identified promotions.

In Example 4, the subject matter of Examples 1-3 includes, wherein the operations further comprise: selecting one or more promotions associated with the selected route based on the bid values; and transmitting promotion data for the selected promotions to the autonomous vehicle for presentation to a rider during the ride.

In Example 5, the subject matter of Examples 1˜4 includes, wherein the operations further comprise: communicating over a network promotion data for a promotion associated with the selected route to a computing device of the autonomous vehicle; wherein the promotion is presented via an in-vehicle display of the autonomous vehicle, the in-vehicle display providing an option that is selectable by a rider of the autonomous vehicle to deviate from the selected route and direct the autonomous vehicle to travel to a place of business associated with the promotion.

In Example 6, the subject matter of Examples 1-5 includes, wherein determining the expected monetary value associated with the route comprises applying a machine learning model to generate a rider acceptance score for each promotion, wherein the rider acceptance score represents a predicted likelihood of the rider interacting with the promotion.

In Example 7, the subject matter of Examples 1-6 includes, wherein the operations further comprise: receiving updated promotion data for a new promotion associated with a location proximate to the current route of the autonomous vehicle during the ride; determining an expected monetary value associated with diverting to the location of the new promotion based on the bid value; and in response to the expected monetary value exceeding a threshold, directing the autonomous vehicle to divert to the location associated with the new promotion.

In Example 8, the subject matter of Examples 1-7 includes, wherein selecting the route comprises applying one or more business rules to filter the promotions associated with each route, wherein the business rules exclude duplicate promotions for a same product or service.

In Example 9, the subject matter of Examples 1-8 includes, wherein the operations further comprise: receiving a selection of an option presented via an in-vehicle display indicating rider acceptance of a promotion; and in response, automatically placing an order for a product or service associated with the promotion on behalf of the rider.

In Example 10, the subject matter of Examples 1-9 includes, wherein the bid value for a promotion is programmatically determined by a computing system of a business based on real-time sales data, inventory data, and wait time data associated with a place of business.

Example 11 is a method for determining a route for a network-connected autonomous vehicle, the method comprising: receiving a ride request indicating a pick-up location and a drop-off location; determining a plurality of routes beginning at the pick-up location and ending at the drop-off location, each route in the plurality of routes satisfying a condition; for each route in the plurality of routes, determining an expected monetary value associated with the route, wherein the expected monetary value is based on bid values for promotions of business entities having a place of business located within a predetermined proximity of the route, and wherein the bid value for a promotion indicates a monetary amount offered by the business entity in exchange for presenting the promotion to a rider during a ride; selecting from the plurality of routes the route with the highest expected monetary value; and providing the selected route to the network-connected autonomous vehicle.

In Example 12, the subject matter of Example 11 includes, wherein the condition is that an expected travel time of the route does not exceed an expected travel time of a default route by more than a threshold amount, the default route determined to be the fastest route.

In Example 13, the subject matter of Examples 11-12 includes, wherein determining the expected monetary value associated with the route comprises: identifying promotions associated with business entities having a place of business located within the predetermined proximity of the route; for each identified promotion, retrieving the bid value associated with presenting the promotion to a rider; and aggregating the bid values for the identified promotions.

In Example 14, the subject matter of Examples 11-13 includes, selecting one or more promotions associated with the selected route based on the bid values; and transmitting promotion data for the selected promotions to the autonomous vehicle for presentation to a rider during the ride.

In Example 15, the subject matter of Examples 11-14 includes, communicating over a network promotion data for a promotion associated with the selected route to a computing device of the autonomous vehicle; wherein the promotion is presented via an in-vehicle display of the autonomous vehicle, the in-vehicle display providing an option that is selectable by a rider of the autonomous vehicle to deviate from the selected route and direct the autonomous vehicle to travel to a place of business associated with the promotion.

In Example 16, the subject matter of Examples 11-15 includes, wherein determining the expected monetary value associated with the route comprises applying a machine learning model to generate a rider acceptance score for each promotion, wherein the rider acceptance score represents a predicted likelihood of the rider interacting with the promotion.

In Example 17, the subject matter of Examples 11-16 includes, receiving updated promotion data for a new promotion associated with a location proximate to the current route of the autonomous vehicle during the ride; determining an expected monetary value associated with diverting to the location of the new promotion based on the bid value; and in response to the expected monetary value exceeding a threshold, directing the autonomous vehicle to divert to the location associated with the new promotion.

In Example 18, the subject matter of Examples 11-17 includes, wherein selecting the route comprises applying one or more business rules to filter the promotions associated with each route, wherein the business rules exclude duplicate promotions for a same product or service.

In Example 19, the subject matter of Examples 11-18 includes, receiving a selection of an option presented via an in-vehicle display indicating rider acceptance of a promotion; and in response, automatically placing an order for a product or service associated with the promotion on behalf of the rider.

In Example 20, the subject matter of Examples 11-19 includes, wherein the bid value for a promotion is programmatically determined by a computing system of a business based on real-time sales data, inventory data, and wait time data associated with a place of business.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A system for selecting a route for a network-connected autonomous vehicle, the system comprising:
a processor; and
a memory storage device storing executable instructions thereon, which, when executed by the processor, cause the system to perform operations comprising:
receiving a ride request indicating a pick-up location and a drop-off location;
determining a plurality of routes beginning at the pick-up location and ending at the drop-off location, each route in the plurality of routes satisfying a condition;
for each route in the plurality of routes, determining an expected monetary value associated with the route, wherein the expected monetary value is based on bid values for promotions of business entities having a place of business located within a predetermined proximity of the route, and wherein the bid value for a promotion indicates a monetary amount offered by the business entity in exchange for presenting the promotion to a rider during a ride;
selecting from the plurality of routes the route with the highest expected monetary value; and
providing the selected route to the network-connected autonomous vehicle.

2. The system of claim 1, wherein the condition is that an expected travel time of the route does not exceed an expected travel time of a default route by more than a threshold amount, the default route determined to be the fastest route.

3. The system of claim 1, wherein determining the expected monetary value associated with the route comprises:
identifying promotions associated with business entities having a place of business located within the predetermined proximity of the route;
for each identified promotion, retrieving the bid value associated with presenting the promotion to a rider; and
aggregating the bid values for the identified promotions.

4. The system of claim 1, wherein the operations further comprise:
selecting one or more promotions associated with the selected route based on the bid values; and
transmitting promotion data for the selected promotions to the autonomous vehicle for presentation to a rider during the ride.

5. The system of claim 1, wherein the operations further comprise:
communicating over a network promotion data for a promotion associated with the selected route to a computing device of the autonomous vehicle;
wherein the promotion is presented via an in-vehicle display of the autonomous vehicle, the in-vehicle display providing an option that is selectable by a rider of the autonomous vehicle to deviate from the selected route and direct the autonomous vehicle to travel to a place of business associated with the promotion.

6. The system of claim 1, wherein determining the expected monetary value associated with the route comprises applying a machine learning model to generate a rider acceptance score for each promotion, wherein the rider acceptance score represents a predicted likelihood of the rider interacting with the promotion.

7. The system of claim 1, wherein the operations further comprise:
receiving updated promotion data for a new promotion associated with a location proximate to the current route of the autonomous vehicle during the ride;
determining an expected monetary value associated with diverting to the location of the new promotion based on the bid value; and
in response to the expected monetary value exceeding a threshold, directing the autonomous vehicle to divert to the location associated with the new promotion.

8. The system of claim 1, wherein selecting the route comprises applying one or more business rules to filter the promotions associated with each route, wherein the business rules exclude duplicate promotions for a same product or service.

9. The system of claim 1, wherein the operations further comprise:
receiving a selection of an option presented via an in-vehicle display indicating rider acceptance of a promotion; and
in response, automatically placing an order for a product or service associated with the promotion on behalf of the rider.

10. The system of claim 1, wherein the bid value for a promotion is programmatically determined by a computing system of a business based on real-time sales data, inventory data, and wait time data associated with a place of business.

11. A method for determining a route for a network-connected autonomous vehicle, the method comprising:
receiving a ride request indicating a pick-up location and a drop-off location;
determining a plurality of routes beginning at the pick-up location and ending at the drop-off location, each route in the plurality of routes satisfying a condition;
for each route in the plurality of routes, determining an expected monetary value associated with the route, wherein the expected monetary value is based on bid values for promotions of business entities having a place of business located within a predetermined proximity of the route, and wherein the bid value for a promotion indicates a monetary amount offered by the business entity in exchange for presenting the promotion to a rider during a ride;
selecting from the plurality of routes the route with the highest expected monetary value; and
providing the selected route to the network-connected autonomous vehicle.

12. The method of claim 11, wherein the condition is that an expected travel time of the route does not exceed an expected travel time of a default route by more than a threshold amount, the default route determined to be the fastest route.

13. The method of claim 11, wherein determining the expected monetary value associated with the route comprises:
identifying promotions associated with business entities having a place of business located within the predetermined proximity of the route;
for each identified promotion, retrieving the bid value associated with presenting the promotion to a rider; and
aggregating the bid values for the identified promotions.

14. The method of claim 11, further comprising:
selecting one or more promotions associated with the selected route based on the bid values; and
transmitting promotion data for the selected promotions to the autonomous vehicle for presentation to a rider during the ride.

15. The method of claim 11, further comprising:
communicating over a network promotion data for a promotion associated with the selected route to a computing device of the autonomous vehicle;
wherein the promotion is presented via an in-vehicle display of the autonomous vehicle, the in-vehicle display providing an option that is selectable by a rider of the autonomous vehicle to deviate from the selected route and direct the autonomous vehicle to travel to a place of business associated with the promotion.

16. The method of claim 11, wherein determining the expected monetary value associated with the route comprises applying a machine learning model to generate a rider acceptance score for each promotion, wherein the rider acceptance score represents a predicted likelihood of the rider interacting with the promotion.

17. The method of claim 11, further comprising:
receiving updated promotion data for a new promotion associated with a location proximate to the current route of the autonomous vehicle during the ride;
determining an expected monetary value associated with diverting to the location of the new promotion based on the bid value; and
in response to the expected monetary value exceeding a threshold, directing the autonomous vehicle to divert to the location associated with the new promotion.

18. The method of claim 11, wherein selecting the route comprises applying one or more business rules to filter the promotions associated with each route, wherein the business rules exclude duplicate promotions for a same product or service.

19. The method of claim 11, further comprising:
receiving a selection of an option presented via an in-vehicle display indicating rider acceptance of a promotion; and
in response, automatically placing an order for a product or service associated with the promotion on behalf of the rider.

20. The method of claim 11, wherein the bid value for a promotion is programmatically determined by a computing system of a business based on real-time sales data, inventory data, and wait time data associated with a place of business.
